(19) United States
(12) Patent Application Publication
(10) Pub. No.: US 2026/0156343 A1
(43) Pub. Date: Jun. 4, 2026

(54) METHOD FOR AUTOMATING THE PAN, ZOOM AND TILT FUNCTIONS OF PTZ CAMERA MOVEMENT

(71) Applicant: Prasad Narasimha Seshadri, MYSORE (IN)

(72) Inventor: Prasad Narasimha Seshadri, MYSORE (IN)

(21) Appl. No.: 19/458,844

(22) Filed: Jan. 25, 2026

Related U.S. Application Data
(63) Continuation-in-part of application No. 17/362,077, filed on Jun. 29, 2021, now abandoned.

(51) Int. Cl. H04N 23/611; G06V 20/62; G06V 40/10; H04N 23/69; H04N 23/695

(52) U.S. Cl. CPC H04N 23/611; G06V 20/62; G06V 40/113; H04N 23/69; H04N 23/695

(57) ABSTRACT

A method and system are disclosed for automating camera movement to zoom in on the latest instructor writing by properly centering the writing in the camera view and applying zoom to achieve clear magnification and focus. The method includes detecting an instructor's hand raise using an artificial intelligence (AI)-based object detection model, determining a center of the latest writing on a board, screen, or display by performing statistical analysis of the writing, and centering the camera on the latest writing based on the determined center. The method further comprises tilting the camera in response to an off-center click on a user interface so as to achieve optimal visibility of the latest writing or an object to which the instructor points. The system enables the writing to be seen clearly without requiring a greater than 100% zoom on the browser of a viewer's laptop, desktop, or mobile device.

### CROSS-REFERENCE TO RELATED APPLICATION

This patent application is a continuation-in-part of U.S. patent application. Ser. No. 17/362,077 filed on Jun. 29, 2021, the entire disclosure of which is incorporated herein by reference.

### CORRESPONDING RELATED APPLICATIONS

The present invention is an improvement of the method described in U.S. Non-Provisional patent application Ser. No. 12/125,395 by Prasad Seshadri, filed on May 22, 2008 and entitled “Method and apparatus for effectively capturing and broadcasting a traditionally delivered classroom or a presentation” and granted on Jun. 13, 2014. Reference is also hereby made to U.S. patent application Ser. No. 11/171,825 by Prasad Seshadri, filed on Jun. 29, 2005, entitled “Method and apparatus for effectively capturing a traditionally delivered classroom or a presentation and making it available for review over the Internet using remote production control” and incorporated by reference herein in its entirety.

### FIELD OF THE INVENTION

The present invention relates to camera control systems for instructional and presentation environments, and more particularly to methods and systems for automatically centering and zooming a camera on writing or objects pointed to by an instructor using artificial intelligence.

### BACKGROUND OF THE INVENTION

Instruction/Presentational content generated by university personnel as well as organizational wisdom created by professionals in organizations are either being lost to posterity or not being harnessed to their full potential, since the content disappears and is preserved imperfectly only in the minds of a few. One of the greatest challenges in introducing technology into classroom or a presentation context is resistance to technology on the part of a traditional Instructor/Presenter, who must focus on Instruction/Presentation and the students/audience rather than be distracted by presentation technology issues, which do not represent his/her core interest or objective, and is therefore unwilling to make the adjustments or compromises necessary to adapt to technology. Automated camera movement helps achieve this objective since it allows the instructor/presenter to be oblivious of technological constraints.

### SUMMARY OF THE INVENTION

The following changes have been implemented to the system described in Ser. No. 12/125,395.

Major disadvantages of the system described in Ser. No. 12/125,395 are as follows:
a. The requirement of a person to control the camera even though the system attempts To make it extremely easy to do so by employing a User Interface with which the cameras can be selected and controlled without fatigue and distraction by mouse clicks for PAN and TILT and the roller for ZOOM functions.
b. The requirement of the instructor to wear any RFID or similar emitters to help achieve automation of camera movement to eliminate the disadvantage posed by requirement to move the cameras manually, is awkward and not practical.

The described methodology aims to eliminate the two disadvantages by developing a Robot that simulates a person manually controlling the camera via the user interface shown in FIG. 4 by means of mouse clicks and roller action or touchpad action for PAN, TILT and ZOOM.

When the instructor moves across the writing surface, an Artificial Intelligence tool like YOLO (You Only Look Once) is used to track the instructor and move the camera automatically so that the camera view is automatically centered on the instructor.

When the instructor has stopped moving across the writing surface, the chosen Artificial Intelligence tool is able to detect if either hand is raised to determine if the camera is to be moved to the left of the instructor or to the right of the instructor to center on the latest writing or anything the instructor might point to before zooming in the camera by simulating the roller operation of a mouse or finger operation of a touchpad.

The ZOOM in factor described in [0005] is programmable

so that any the degree of zoom can be increased or decreased based on the degree of magnification required.

However, automating only the PAN and ZOOM still does not center the camera on the latest writing or whatever the instructor points to. If the camera view of the writing is towards the top of the writing surface or the bottom of the writing surface.

In the zoomed in position, the program further analyzes the degree by which the latest writing is off-center in the vertical direction.

The camera is tilted upward or downward depending on the degree and direction of the off-center. This brings the writing closer to the center of the latest writing or whatever the instructor is pointing to.

This will enable the writing or whatever the instructor points to be seen very clearly by a viewer replaying the recording from a server without having to require a digital zoom on the browser or to have to put the video on full-screen mode.

Automation of camera movement means there is no one to monitor if the microphone is working. Therefore, following steps are taken to minimize the microphone related problems. Two long corded lapel microphones are provided—one acting as a spare.

Wired microphone eliminates the requirement to assign different frequency channels to adjoining or nearby classrooms. The microphone goes directly into the microphone input of the desktop computer. The encoder desktop software enables the input audio to be routed back to the headphone output for monitoring. This output is sent to a mixer for amplification. An external speaker is connected to the speaker output of the mixer. This enables the instructor to hear his/her own voice thereby enabling him/her to know that the audio is functioning properly.

### BRIEF DESCRIPTION OF THE DRAWINGS

FIG. 1 illustrates how blackboard-based writings appear without camera zoom.

FIG. 2 illustrates how blackboard-based writing appears magnified because of only camera zoom but no tilt to center the writing to the camera field of view.

FIG. 3 illustrates how the blackboard-based writing appears both magnified and centered when the camera is tilted to center the writing to the camera field of view.

FIG. 4 is reproduced from U.S. Pat. No. 8,831,505 B1 (application Ser. No. 12/125,395) to illustrate one embodiment of the Production Control User Interface.

### DETAILED DESCRIPTION OF THE INVENTION

In various embodiments, a system for artificial intelligence (AI)-based hand detection, statistical and image-based analysis of writing or displayed objects, and native camera control via an application programming interface (API) is disclosed. The system enables dynamic camera movements in real time to center on the latest writing or objects pointed to by an instructor, while avoiding vertical misalignment and optimizing visibility for remote or recorded audiences. Specifically, the embodiments described herein provide an improvement over existing camera control systems. The current improvement is directed to completely automating camera movement based on the context of what the instructor's action, thereby allowing the instructor or presenter to remain oblivious to technological constraints. Unlike prior approaches requiring manual intervention or fixed presets, the disclosed methods integrate artificial intelligence-based gesture detection, statistical and image-based analysis of writing, and native API camera control to dynamically and autonomously frame the latest writing or object of interest.

The methods and systems described herein are applicable to a wide range of camera configurations. In some embodiments, the camera is integrated into an interactive whiteboard system, a smart classroom display, or a conference room audiovisual system. In other embodiments, the camera is part of a lecture capture system, a document camera, a robotic camera head, or a pan-tilt-zoom (PTZ) camera used in studio or live event production. The camera may also be embedded in a computing device, such as a desktop computer, laptop, tablet, or mobile device, or incorporated into a wearable device, such as smart glasses or a body-worn camera. In further embodiments, the camera is mounted as part of a ceiling-or wall-mounted surveillance system, a videoconferencing endpoint, or an automated broadcast system.

The invention is also applicable where the camera is a standalone device connected to the system through wired or wireless communication links, including Ethernet, Wi-Fi, cellular, or other IP-based connections. Standalone cameras may be mounted on tripods, robotic mounts, gimbals, drones, or other supports, and may include optical zoom, digital zoom, and integrated or external pan/tilt mechanisms. The scope of the invention encompasses any imaging device capable of providing a video feed suitable for the AI-based detection, statistical analysis, and camera control functions described herein.

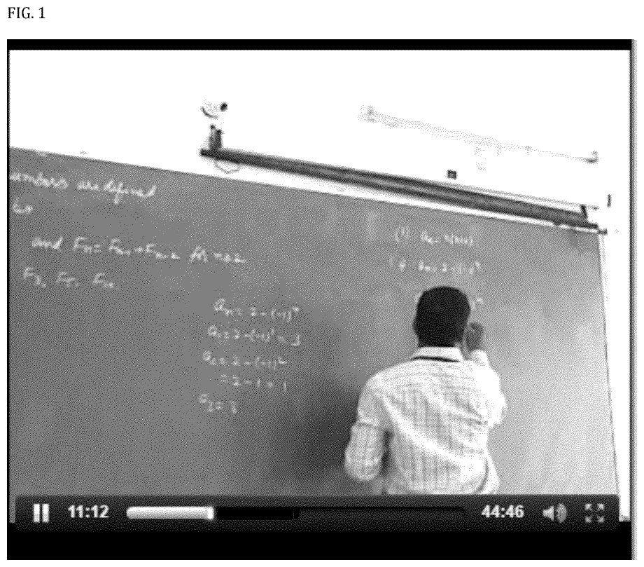

Referring to FIG. 1, the illustration shows how blackboard-based writings appear in the camera's field of view without any camera zoom applied. In this state, while the entire instructional surface may be visible, the individual written characters, symbols, or diagrams may appear too small for remote viewers or recording playback, thereby resulting in reduced legibility.

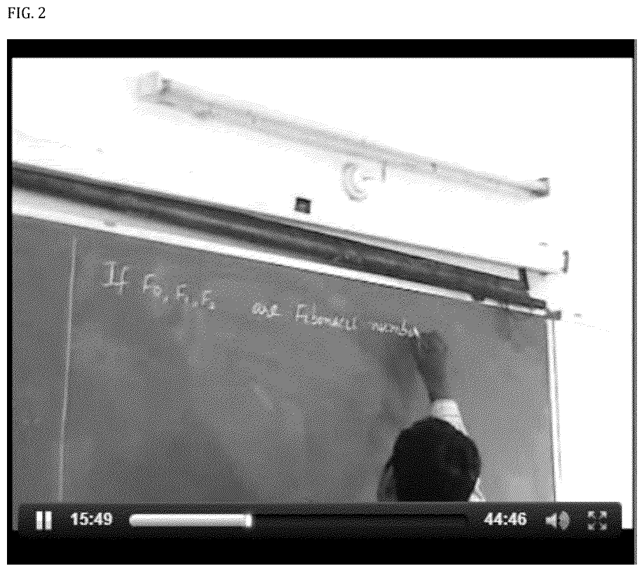

Referring to FIG. 2, the illustration depicts how blackboard-based writing appears when the camera is optically zoomed in but no tilt adjustment is made to center the writing within the camera's field of view. In such cases, although the writing is magnified for improved legibility, it may be positioned toward the top, bottom, or side of the frame, causing partial cutoff or suboptimal framing. This view illustrates the limitation of zoom-only adjustments without incorporating tilt for proper centering.

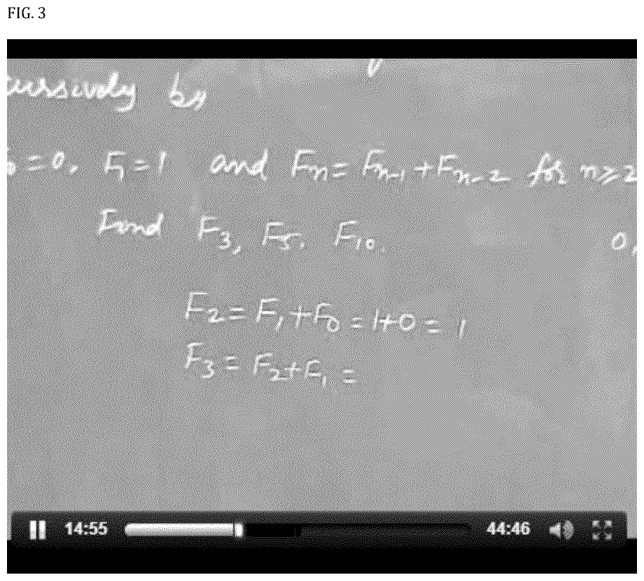

Referring to FIG. 3, the illustration depicts how blackboard-based writing appears when the camera is both optically zoomed in and tilted so as to center the latest writing within the field of view. By executing both zoom and tilt adjustments—such as those triggered by AI-based detection and statistical or image-based analysis—the writing is presented at an enlarged scale while remaining centrally positioned, thereby ensuring maximum legibility and optimal visibility for viewers. This figure represents the intended operational result of the present invention.

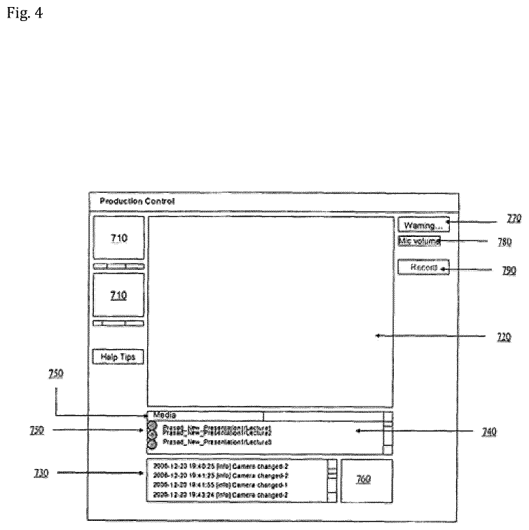

Referring to FIG. 4, reproduced from Applicant's U.S. Pat. No. 8,831,505 B1, illustrates one embodiment of a production control user interface 700 that may be employed in conjunction with the claimed methods. The interface enables a production controller to monitor and control multiple camera views, select a primary video feed, track events and camera changes, monitor file status and upload progress, view the latest slide selection, and assess audio levels in real time. The interface further includes operational state indicators and recording controls, providing an environment in which AI-based detection, statistical analysis of writing, and native API-driven camera movements can be integrated. Referring to FIG. 4, the system is integrated with a production control user interface 700, which enables a production controller to monitor and manage multiple camera views and recording operations.

In the illustrated embodiment, a plurality of thumbnail images 710 represent the available camera views, of which there may be more than two. A video image window 720 displays the currently selected primary view. A status report window 730 lists events occurring on the Instructor/Presenter's computer as well as events detected during recording, such as changes in camera selection or slides being advanced.

A file status window 740 provides visual indicators of recording and upload states. In certain embodiments, an empty red icon indicates that recording is in progress; a red upward arrow icon indicates that a file is being uploaded; and a red check-mark icon indicates that a file has been successfully uploaded to the streaming server. A slide preview window 760 displays the most recently selected slide to provide contextual awareness for the production controller.

An operational state indicator box 770 displays “Waiting” when the Instructor/Presenter is preparing for the lecture or presentation, “Ready” when setup is complete, and “Recording” once recording has commenced. A microphone level indicator 780, positioned adjacent to a microphone symbol, displays the audio signal level being sent to the recorder. This allows the production controller to verify that both the Instructor/Presenter microphone and the audience microphone are active by instructing someone to speak into each. The microphone level indicator remains active even before recording begins.

In some embodiments, a headphone output is connected to the line output of the Classroom Server for the production controller to audibly monitor the signal for quality assurance. The mixer may be used to adjust the input volume level before recording. A record button 790 initiates recording and becomes active only when the system is ready. Upon commencement of recording, additional buttons, such as “Pause” and “Stop,” become visible and active for controlling the recording process.

In certain embodiments, a method is provided for performing intermediate zooming without vertical offset in an instructional or presentation environment. The method includes detecting an instructor's hand raise using an artificial intelligence (AI)-based object detection model. In some embodiments, the object detection model comprises a You Only Look Once (YOLO) detection architecture or a functionally equivalent AI model trained to identify hand-raising gestures.

Upon detecting the instructor's hand raise, the method further comprises determining a center of the latest writing on a board, screen, or display by performing statistical analysis of the writing, wherein the statistical analysis may include identifying regions of newly added content, computing a bounding box, and calculating its geometric center. The camera is then centered on the latest writing based on the determined center, and the camera is tilted accordingly in response to an off-center click on a user interface so as to achieve optimal visibility of the latest writing or an object to which the instructor points.

In some embodiments, pointing the camera directly to the center of the latest writing or an object to which the instructor points comprises estimating coordinates of the center using image processing. These estimated coordinates may be selected via a click on a user interface, which in turn causes the camera to move and center the latest writing within the field of view.

In other embodiments, achieving optimal visibility of the latest writing or an object to which the instructor points comprises moving the camera a predetermined distance to the right of the instructor when the instructor's right hand is raised, and moving the camera a predetermined distance to the left of the instructor when the instructor's left hand is raised. In these implementations, the system may be calibrated such that the latest writing or object is positioned a predetermined distance from the instructor's body, thereby ensuring that the subject matter is clearly visible to viewers.

In yet other embodiments, all camera movements are executed by initiating the movements through a native Application Programming Interface (API) rather than through a graphical user interface. The camera feed may be accessed via a browser using the camera's Internet Protocol (IP) address, allowing direct, low-latency communication for executing pan, tilt, and zoom commands without intermediate software layers.

Although specific examples of hardware, software, and algorithms are described herein for purposes of illustrating certain embodiments of the invention, it will be understood that the claimed methods and systems are not limited to those particular implementations. Equivalent devices, modules, and subsystems capable of performing substantially the same functions in substantially the same way to achieve substantially the same results may be substituted without departing from the scope of the invention. Such equivalents may include different brands or models of cameras, alternative AI object detection architectures, varied image processing algorithms, and different native API control protocols, provided that they implement the functions described herein. The term “camera” as used in this specification and the appended claims is intended to encompass any imaging device capable of panning, tilting, and zooming in response to control commands, whether fixed, portable, robotic, or integrated into another system.

It will finally be understood that the disclosed embodiments are presently preferred examples of how to make and use the claimed invention, and are intended to be explanatory rather than limiting the scope of the invention as defined by the claims below. Reasonable variations and modifications of the illustrated examples in the foregoing written specification and drawings are possible without departing from the scope of the invention as defined in the claim below. It should further be understood that to the extent the term “invention” is used in the written specification, it is not to be construed as a limited term as to number of claimed or disclosed inventions or the scope of any such invention, but as a term which has long been conveniently and widely used to describe new and useful improvements in technology. The scope of the invention supported by the above disclosure should accordingly be construed within the scope of what it teaches and suggests to those skilled in the art, and within the scope of any claims that the above disclosure supports. The scope of the invention is accordingly defined by the following claims.

1. A method for intermediate zooming without vertical offset, the method comprising:
detecting an instructor's hand raise using artificial intelligence (AI)-based object detection model;
determining a center of latest writing on a board, screen, or display by performing statistical analysis of the writing;
centering a camera on the latest writing based on the determined center; and
tilting the camera accordingly in response to an off-center click on a user interface so as to achieve optimal visibility of the latest writing or an object to which the instructor points.

2. The method of claim 1, wherein pointing the camera directly to a center of latest writing or an object to which the instructor points comprises:
estimating coordinates of the center of the latest writing using image processing; and
causing the camera movement to center the latest writing by selecting the estimated coordinates via a click on a user interface.

3. The method of claim 1, wherein achieving optimal visibility of the latest writing or an object to which the instructor points comprises:
moving the camera a predetermined distance to a right of the instructor when the instructor's right hand is raised; and
moving the camera a predetermined distance to a left of the instructor when the instructor's left hand is raise, wherein the latest writing or the object is positioned a predetermined distance from the instructor's body to be clearly visible to viewers.

4. The method of claim 1, wherein camera movements are executed by initiating the movements through a native Application Programming Interface (API) rather than via a graphical user interface, by accessing a camera feed through a browser using the camera's Internet Protocol (IP) address.

5. The method of claim 1, wherein the user interface is implemented in a production control interface, the production control interface comprising:
a thumbnail view window displaying a plurality of camera feeds;
a primary video window displaying a selected camera feed;
a status report window indicating events occurring on an instructor's computer and events during recording;
a file status window indicating recording, uploading, and upload completion states;
a slide preview window displaying a latest selected slide;
operational state indicators displaying a “waiting,” “ready,” or “recording” status;
an audio monitoring interface including a microphone level indicator; and
recording control buttons configured to initiate, pause, and stop recording.
